(19) United States
(12) Patent Application Publication
(10) Pub. No.: US 2007/0209597 A1
(43) Pub. Date: Sep. 13, 2007

(54) Adjustable mounting bracket for feed buckets and the like

(76) Inventors: Ted A. Brock, Morgantown, IN (US); Ronald G. Brock, Trafalgar, IN (US)

Correspondence Address: ASHKAN NAJAFI, P.A., 6817 SOUTHPOINT PARKWAY, SUITE 2301, JACKSONVILLE, FL, 32216, US

(21) Appl. No.: 11/371,264

(22) Filed: Mar. 9, 2006

(51) Int. Cl. A01K 5/00

(52) U.S. Cl. 119/51.01

(57) ABSTRACT

A non-corrosive mounting bracket includes first and second members that have L-shapes and include horizontal and vertical portions defining a 90 degree elbow. The first member vertical portion is abutted against a post's rear surface and has a fastener assembly attached thereto. The fastener assembly includes a bolt and wing nut. The second member's vertical portion is abutted against the post's front surface, and the horizontal portion extends rearward along the post and travels parallel to the first member horizontal portion. The second member horizontal portion has a slot so that the fastener assembly is slidably positionable along the slot. L-shaped fingers are formed with the second member and protrude forwardly away from the post for receiving select portions of the feed bucket so that the bucket is maintained at a static position during feeding procedures.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to mounting brackets and, more particularly, to an adjustable mounting bracket for feed buckets and the like.

2. Prior Art

The raising of horses is a major industry as well as a hobby or major avocation for many persons in the United States and around the world. The horses' life is spent mostly out of doors. Under the best of circumstances, when weather allows, the horse is most content when running free in a fenced in enclosure. It would be preferable for the horse to enter a building only to sleep at night. However, it is necessary, using present devices and methods, to bring the horses indoors when feeding. As a consequence, it is necessary for the owner or his agents to go outside, round up the horses, and bring them indoors for each feedings. A horse is normally fed twice a day and it is desirable not to feed the horse just before the horse goes to sleep for health reasons. As a consequence, it is necessary to bring the horses in and then let the horses out into an open area after feeding. This requires inconvenient personal time for the hobbyist and a substantial manpower cost for the professional horse breeder.

Although many domesticated animals are fed outdoors, horses commonly contract “sand colic” if they eat outdoors. This condition may be lethal and at best is a serious illness. The condition is contracted during the eating process. The nature of the granular feed and the horses' eating habits typically spill a substantial amount of food on the ground. The horse, upon finishing the feed in the feed bucket will then proceed to eat any food that has dropped on the ground. Unless the ground is absolutely clean of dirt, the horse, must of necessity, eat a substantial amount of sand and dirt. This causes sand colic and results in the death of hundreds, if not thousands, of horses each year.

In attempt to overcome this problem, a prior art apparatus to avoid the ailment of sand colic in horses has been introduced. Such an apparatus includes a fenced in area with a fence section that does not allow the horse to stick its head through the fence to reach the ground on the outside of the fence section. A feed bucket is supported on a holder on the outside of the fence section such that the horse must lean over the top rail of the fence to eat from the bucket and cannot reach any spilled feed on the ground. The feeding device includes a metal bracket with a circular ring in which the feed bucket fits with a horizontal support member to support the feed bucket from the bottom. The ring and support are welded to a bracket plate which in turn is attached to the fence post.

Unfortunately, such an apparatus has several draw backs. The most obvious of which is that the apparatus is affixed at a stationary and permanent position once it is attached to the fence. This greatly limits the versatility of the apparatus for feeding horses that are located at remote locations form each other from the same apparatus. Thus the owner must purchase multiple apparatuses, which can become quite expensive and labor intensive when installation time is taken into consideration. A further disadvantage is that the apparatus is limited to suspending a bucket of one size only, thus not allowing the user to vary the amount of feed that a horse is consuming. In the case of race-horses, or a horse suffering from a certain ailment, such control over the amount of feed being consumed may become vital to the overall health of the animal.

Accordingly, a need remains for an adjustable mounting bracket for feed buckets and the like in order to overcome the above-noted shortcomings. The present invention satisfies such a need by providing a mounting bracket that is easy and convenient to use, is durable and practical in design, and is lightweight and corrosion resistant for extended periods of use. Such a mounting bracket is easily used with various sizes of brackets and, once mounted to the fence, can accommodate a full bucket of water as well. The horse can thereafter drink or eat from the attached bucket without spilling the contents thereof. The mounting bracket is also easily adaptable to be attached to fences of varying widths, further increasing the versatility thereof. Such a mounting bracket finds appeal among private owners, as well as professional trainers and caretakers of horses.

### BRIEF SUMMARY OF THE INVENTION

In view of the foregoing background, it is therefore an object of the present invention to provide an adjustable mounting bracket for feed buckets and the like. These and other objects, features, and advantages of the invention are provided by an adjustable mounting bracket for securely holding a feed bucket at an elevated position and adjacent to a support post.

The mounting bracket, formed from non-corrosive material, includes a first member that has an L-shape and includes monolithically formed horizontal and vertical portions defining a 90 degree elbow. Such a first member horizontal portion is preferably spaced from the support post and positioned rearward of the support post. The first member vertical portion is directly and contiguously abutted against a rear surface of the support post. The first member further has a fastener assembly permanently attached to the first member horizontal portion that protrudes vertically upwards therefrom and terminates above the support post. Such a fastener assembly includes a threaded bolt and a wing nut removably attached thereto.

In alternate position, the 90 degree elbow of the first member is preferably firmly engaged directly against a top edge of the support post such that the first member horizontal portion traverses directly over the top edge and contiguously abuts thereagainst. At such a position, the second member horizontal portion is spaced above the top edge of the support post. The first member horizontal portion may have a longitudinal length that is shorter than a longitudinal length of the second member horizontal portion so that the support post can effectively be intercalated between the first and second member vertical portions respectively.

A second member has an L-shape and includes monolithically formed horizontal and vertical portions defining a 90 degree elbow. Such a 90 degree elbow of the second member is preferably firmly engaged directly against a top edge of the support post such that the second member horizontal portion effectively traverses directly over the top edge and contiguously abuts thereagainst. The second member vertical portion is directly and contiguously abutted against a front surface of the support post while the second member horizontal portion extends rearwardly along the support post. Such a second member horizontal portion travels along a linear path registered parallel to the first member horizontal portion.

The second member horizontal portion has a linear slot formed therein in such a manner that the fastener assembly can advantageously and effectively be slidably positioned along a longitudinal length of the slot so that a user can adjustably adapt a spatial distance between the vertical portions of the first and second members and conveniently attach the mounting bracket to various sized support posts respectively.

A plurality of L-shaped fingers are monolithically formed with the second member and protrude forwardly away from the support post. Such L-shaped fingers receive first and second portions of the feed bucket in such a manner that the feed bucket is advantageously and conveniently maintained at a substantially static position during feeding procedures. One of the fingers may be disposed at a top end of the second member vertical portion and adjacent to the 90 degree elbow of the second member. Such one finger has a vertically oriented portion for advantageously and effectively preventing a handle of the feed bucket from disengaging the one finger during feeding procedures. Another one of the fingers is preferably monolithically formed with a bottom edge of the second member vertical portion and includes a vertical portion positioned upwardly and directly against an outer lip of the feed bucket for conveniently and effectively preventing the feed bucket from oscillating about the bucket handle during feeding procedures.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is an exploded perspective view showing an adjustable mounting bracket for feed buckets and the like, in accordance with the present invention;

FIG. 2 is a perspective view of the apparatus shown in FIG. 1, showing the first members slidably engaged with the second member by means of the fastener assembly;

FIG. 3 is a side-elevational view of the apparatus show in FIG. 2, showing the apparatus positioned along a support post;

FIG. 4 is a top plan view of the apparatus shown in FIG. 1; and

FIG. 5 is a side elevational view of the apparatus shown in FIG. 1, showing the first member at an alternate position for allowing the apparatus to effectively engage a larger support post.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

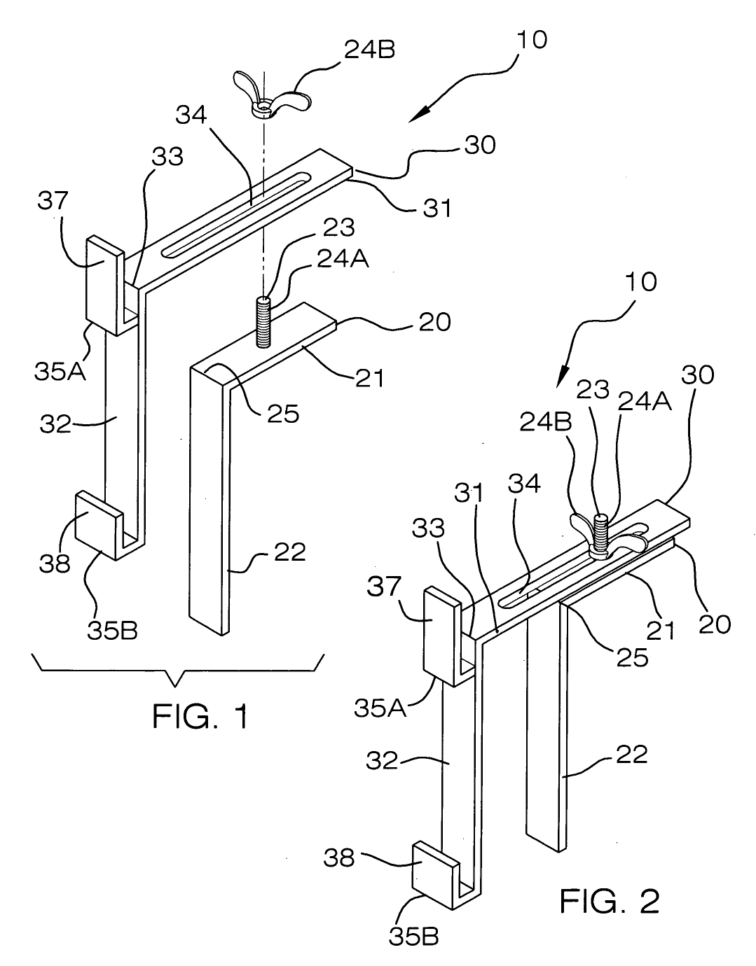

The apparatus of this invention is referred to generally in FIGS. 1-5 by the reference numeral 10 and is intended to provide an adjustable mounting bracket for feed buckets and the like. It should be understood that the apparatus 10 may be used to support many different types of items and should not be limited in use to only supporting support buckets from conventional support posts.

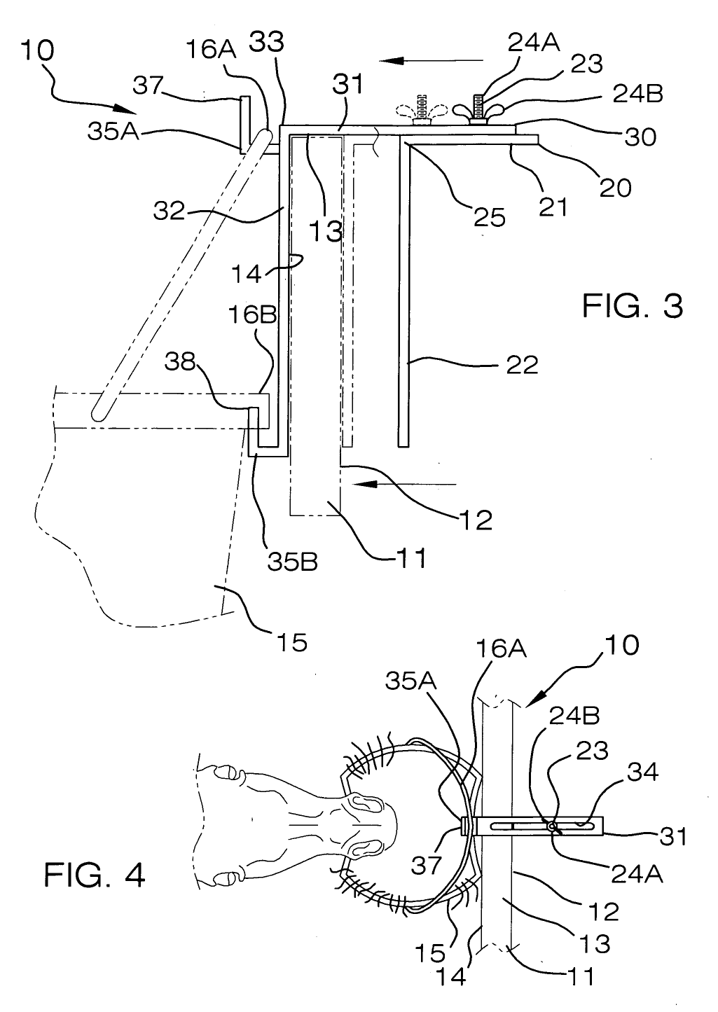

Referring initially to FIGS. 1, 2, 3 and 4, the apparatus 10, formed from non-corrosive material, includes a first member 20 that has an L-shape and includes monolithically formed horizontal 21 and vertical 22 portions defining a 90 degree elbow 25. At a first position, such a first member horizontal portion 21 is spaced from the support post 11 and positioned rearward of the support post 11, as is best shown in FIG. 3. The first member vertical portion 22 is directly and contiguously abutted, without the use of intervening elements, against a rear surface 12 of the support post 11. The first member 20 further has a fastener assembly 23 permanently attached, without the use of intervening elements, to the first member horizontal portion 21 that protrudes vertically upwards therefrom and terminates above the support post 11. Such a fastener assembly 23 includes a threaded bolt 24A and a wing nut 24B removably attached thereto.

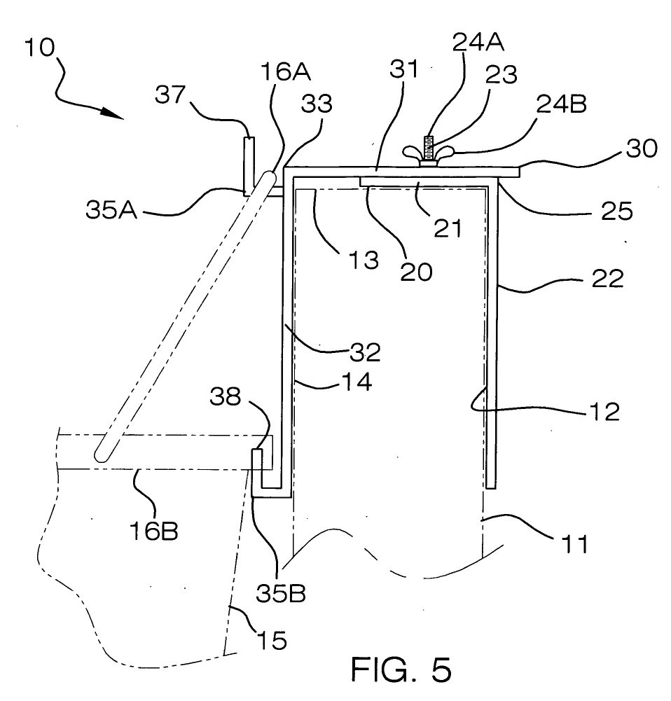

Referring to FIG. 5, at a second position, the 90 degree elbow 25 of the first member 20 is firmly engaged directly, without the use of intervening elements, against a top edge 13 of the support post 11 such that the first member horizontal portion 21 traverses directly over the top edge 13 and contiguously abuts thereagainst. At such a second position, the second member horizontal portion 31 (described herein below) is spaced above the top edge 13 of the support post 11. The first member horizontal portion 21 has a longitudinal length that is shorter than a longitudinal length of the second member horizontal portion 31, which is essential and advantageous so that the support post 11 can effectively be intercalated between the first 22 and second 32 member (described herein below) vertical portions respectively.

Referring to FIGS. 1, 2, 3 and 4, a second member 30 has an L-shape and includes monolithically formed horizontal 31 and vertical 32 portions defining a 90 degree elbow 33. Such a 90 degree elbow 33 of the second member 30 is firmly engaged directly, without the use of intervening elements, against a top edge 13 of the support post 11 such that the second member horizontal portion 31 effectively traverses directly over the top edge 13 and contiguously abuts thereagainst. The second member vertical portion 32 is directly and contiguously abutted, without the use of intervening elements, against a front surface 14 of the support post 11 while the second member horizontal portion 31 extends rearwardly along the support post. Such a second member horizontal portion travels along a linear path registered parallel to the first member horizontal portion 21.

The second member horizontal portion 31 has a linear slot 34 formed therein in such a manner that is crucial for allowing the fastener assembly 23 to advantageously and effectively be slidably positioned along a longitudinal length of the slot 34. This is a vital feature so that a user can effectively and adjustably adapt a spatial distance between the vertical portions 22, 32 of the first 20 and second 30 members, and conveniently attach the mounting bracket 10 to various sized support posts 11 respectively, as is illustrated in FIGS. 3 and 5.

Referring to FIGS. 1 through 5, a plurality of L-shaped fingers 35 are monolithically formed with the second member 30 and protrude forwardly away from the support post 11. Such L-shaped fingers 35 receive first 16A and second 16B portions of the feed bucket 15 in such a manner that is important for allowing the feed bucket 15 to advantageously and conveniently be maintained at a substantially static position during feeding procedures. This feature is crucial for limiting the mount of spillage that occurs during the normal feeding procedures of a horse, or any other suitable animal.

One of the fingers 35A is disposed at a top end 36A of the second member vertical portion 32 and adjacent to the 90 degree elbow 33 of the second member 30. Such one finger 35A has a vertically oriented portion 37 that essential for advantageously and effectively preventing a handle 16A of the feed bucket 15 from disengaging the one finger 35A during feeding procedures, thus ensuring that feed bucket 15 remains suspended from the apparatus 10, even during vigorous periods of feeding. Another one of the fingers 35B is monolithically formed with a bottom edge 36B of the second member vertical portion 32 and includes a vertical portion 38 positioned upwardly and directly against, without the use of intervening elements, an outer lip 16B of the feed bucket 15 that is important for conveniently and effectively preventing the feed bucket 15 from oscillating about the bucket handle 16A during feeding procedures. The one finger vertical portion 37 has a greater vertical length than the other finger vertical portion 38.

In use, a horse owner or caretaker simply places the apparatus 10 over a support post 11 or similar support surface, and slides the first member 20 along the slot 34 until the apparatus 10 is firmly engaged about the post 11. The apparatus 10 is then easily and temporarily fixed in place by tightening the wing nut 24B about the threaded bolt 24A. Should the width of the post 11 exceed the distance between the vertical portions 22, 32 when the first member 20 is at a first position shown in FIGS. 1 through 4, a user can quickly and easily adapt the first member 20 to a second position, shown in FIG. 5, for advantageously and effectively increasing the distance between the respective vertical portions 22, 32.

This feature greatly increases the versatility and usefulness of the apparatus 10 for both private and commercial horse owners. A feed bucket 15, filled with either food or water, is then suspended from the apparatus 10 by attaching the bucket handle 16A to the one finger 35A and securing the bucket outer lip 16B to the other finger 35B. The horse can then eat or drink the bucket contents at its leisure without upsetting the contents thereof.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. An adjustable mounting bracket for securely holding a feed bucket at an elevated position and adjacent to a support post, said mounting bracket comprising:
a first member having an L-shape and including monolithically formed horizontal and vertical portions defining a 90 degree elbow, said first member vertical portion being directly and contiguously abutted against a rear surface of the support post, said first member further having a fastener assembly permanently attached to said first member horizontal portion and protruding vertically upwards therefrom and terminating above the support post;
a second member having an L-shape and including monolithically formed horizontal and vertical portions defining a 90 degree elbow, said second member vertical portion being directly and contiguously abutted against a front surface of the support post while said second member horizontal portion extends rearwardly along the support post, said second member horizontal portion traveling along a linear path registered parallel to said first member horizontal portion, said second member horizontal portion having a linear slot formed therein in such a manner that said fastener assembly can be slidably positioned along a longitudinal length of said slot so that a user can adjustably adapt a spatial distance between said vertical portions of said first and second members and attach said mounting bracket to various sized support posts respectively; and
a plurality of L-shaped fingers monolithically formed with said second member and protruding forwardly away from the support post, said L-shaped fingers receiving first and second portions of the feed bucket in such a manner that the feed bucket is maintained at a substantially static position during feeding procedures.

2. The apparatus of claim 1, wherein said 90 degree elbow of said second member is firmly engaged directly against a top edge of the support post such that said second member horizontal portion traverses directly over the top edge and contiguously abuts thereagainst, said first member horizontal portion being spaced from the support post and positioned rearward of the support post.

3. The apparatus of claim 1, wherein said 90 degree elbow of said first member is firmly engaged directly against a top edge of the support post such that said first member horizontal portion traverses directly over the top edge and contiguously abuts thereagainst, said second member horizontal portion being spaced above the top edge of the support post.

4. The apparatus of claim 1, wherein said first member horizontal portion has a longitudinal length that is shorter than a longitudinal length of said second member horizontal portion so that the support post can be intercalated between said first and second member vertical portions respectively.

5. The apparatus of claim 1, wherein one of said fingers is disposed at a top end of said second member vertical portion and adjacent to said 90 degree elbow of said second member, said one finger having a vertically oriented portion for preventing a handle of the feed bucket from disengaging said one finger during feeding procedures.

6. The apparatus of claim 1, wherein another one of said fingers is monolithically formed with a bottom edge of said second member vertical portion and includes a vertical portion positioned upwardly and directly against an outer lip of the feed bucket for preventing the feed bucket from oscillating about the bucket handle during feeding procedures.

7. An adjustable mounting bracket for securely holding a feed bucket at an elevated position and adjacent to a support post, said mounting bracket comprising:
a first member having an L-shape and including monolithically formed horizontal and vertical portions defining a 90 degree elbow, said first member vertical portion being directly and contiguously abutted against a rear surface of the support post, said first member further having a fastener assembly permanently attached to said first member horizontal portion and protruding vertically upwards therefrom and terminating above the support post;
a second member having an L-shape and including monolithically formed horizontal and vertical portions defining a 90 degree elbow, said second member vertical portion being directly and contiguously abutted against a front surface of the support post while said second member horizontal portion extends rearwardly along the support post, said second member horizontal portion traveling along a linear path registered parallel to said first member horizontal portion, said second member horizontal portion having a linear slot formed therein in such a manner that said fastener assembly can be slidably positioned along a longitudinal length of said slot so that a user can adjustably adapt a spatial distance between said vertical portions of said first and second members and attach said mounting bracket to various sized support posts respectively; and
a plurality of L-shaped fingers monolithically formed with said second member and protruding forwardly away from the support post, said L-shaped fingers receiving first and second portions of the feed bucket in such a manner that the feed bucket is maintained at a substantially static position during feeding procedures;
wherein said mounting bracket is formed from non-corrosive material.

8. The apparatus of claim 7, wherein said 90 degree elbow of said second member is firmly engaged directly against a top edge of the support post such that said second member horizontal portion traverses directly over the top edge and contiguously abuts thereagainst, said first member horizontal portion being spaced from the support post and positioned rearward of the support post.

9. The apparatus of claim 7, wherein said 90 degree elbow of said first member is firmly engaged directly against a top edge of the support post such that said first member horizontal portion traverses directly over the top edge and contiguously abuts thereagainst, said second member horizontal portion being spaced above the top edge of the support post.

10. The apparatus of claim 7, wherein said first member horizontal portion has a longitudinal length that is shorter than a longitudinal length of said second member horizontal portion so that the support post can be intercalated between said first and second member vertical portions respectively.

11. The apparatus of claim 7, wherein one of said fingers is disposed at a top end of said second member vertical portion and adjacent to said 90 degree elbow of said second member, said one finger having a vertically oriented portion for preventing a handle of the feed bucket from disengaging said one finger during feeding procedures.

12. The apparatus of claim 7, wherein another one of said fingers is monolithically formed with a bottom edge of said second member vertical portion and includes a vertical portion positioned upwardly and directly against an outer lip of the feed bucket for preventing the feed bucket from oscillating about the bucket handle during feeding procedures.

13. An adjustable mounting bracket for securely holding a feed bucket at an elevated position and adjacent to a support post, said mounting bracket comprising:
a first member having an L-shape and including monolithically formed horizontal and vertical portions defining a 90 degree elbow, said first member vertical portion being directly and contiguously abutted against a rear surface of the support post, said first member further having a fastener assembly permanently attached to said first member horizontal portion and protruding vertically upwards therefrom and terminating above the support post, wherein said fastener assembly comprises: a threaded, bolt and a wing nut removably attached thereto;
a second member having an L-shape and including monolithically formed horizontal and vertical portions defining a 90 degree elbow, said second member vertical portion being directly and contiguously abutted against a front surface of the support post while said second member horizontal portion extends rearwardly along the support post, said second member horizontal portion traveling along a linear path registered parallel to said first member horizontal portion, said second member horizontal portion having a linear slot formed therein in such a manner that said fastener assembly can be slidably positioned along a longitudinal length of said slot so that a user can adjustably adapt a spatial distance between said vertical portions of said first and second members and attach said mounting bracket to various sized support posts respectively; and
a plurality of L-shaped fingers monolithically formed with said second member and protruding forwardly away from the support post, said L-shaped fingers receiving first and second portions of the feed bucket in such a manner that the feed bucket is maintained at a substantially static position during feeding procedures;
wherein said mounting bracket is formed from non-corrosive material.

14. The apparatus of claim 13, wherein said 90 degree elbow of said second member is firmly engaged directly against a top edge of the support post such that said second member horizontal portion traverses directly over the top edge and contiguously abuts thereagainst, said first member horizontal portion being spaced from the support post and positioned rearward of the support post.

15. The apparatus of claim 13, wherein said 90 degree elbow of said first member is firmly engaged directly against a top edge of the support post such that said first member horizontal portion traverses directly over the top edge and contiguously abuts thereagainst, said second member horizontal portion being spaced above the top edge of the support post.

16. The apparatus of claim 13, wherein said first member horizontal portion has a longitudinal length that is shorter than a longitudinal length of said second member horizontal portion so that the support post can be intercalated between said first and second member vertical portions respectively.

17. The apparatus of claim 13, wherein one of said fingers is disposed at a top end of said second member vertical portion and adjacent to said 90 degree elbow of said second member, said one finger having a vertically oriented portion for preventing a handle of the feed bucket from disengaging said one finger during feeding procedures.

18. The apparatus of claim 13, wherein another one of said fingers is monolithically formed with a bottom edge of said second member vertical portion and includes a vertical portion positioned upwardly and directly against an outer lip of the feed bucket for preventing the feed bucket from oscillating about the bucket handle during feeding procedures.
